(19) United States
(12) Patent Application Publication
(10) Pub. No.: US 2008/0145122 A1
(43) Pub. Date: Jun. 19, 2008

(54) IMAGE FORMING APPARATUS

(75) Inventors: Tamotsu Kaneko, Suntoh-gun (JP); Takayuki Miyamoto, Suntoh-gun (JP); Hiroshi Kawamura, Suntoh-gun (JP); Kazushi Ino, Suntoh-gun (JP); Katsuhiko Oba, Odawara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/942,112

(22) Filed: Nov. 19, 2007

(30) Foreign Application Priority Data
Dec. 19, 2006 (JP) 2006-341399

(51) Int. Cl. G03G 21/00

(52) U.S. Cl. 399/388

(57) ABSTRACT

An image forming apparatus includes at least one image forming unit configured to form an image, a belt for transferring an image formed by the image forming unit onto a recording material, and an opening and closing unit having the belt and openable and closable relative to a main body of the apparatus. The belt is provided above the image forming unit, and the image forming unit is removable from the main body of the apparatus when the opening and closing unit is open. The opening and closing unit slides substantially horizontally, thereby opening and closing relative to the main body of the apparatus.

### BACKGROUND OF THE INVENTION

1. Field of the Invention

The present invention relates to image forming apparatuses such as copiers, printers, and facsimiles, and more specifically, it relates to image forming apparatuses in which an opening and closing unit is opened relative to a main body of the apparatus so that image forming units can be removed and installed.

2. Description of the Related Art

In recent years, color image forming apparatuses have been downsized and often installed on a desktop. The apparatuses are desirably operated from the front thereof.

In view of installation on a desktop, accessibility to the paper output portion, which is most frequently accessed by the user, is particularly important. Emphasis is placed on the height and paper output direction of the paper output portion.

Since the apparatuses are often installed on a desktop as described above, some of the apparatuses are configured so that the user can remove and install image forming units and remove jammed paper from the front of the apparatus.

FIG. 27 shows one such example. The user opens a front door 241 and a top door 242 to access image forming units 243. This structure is called a clam shell structure.

Since color image forming apparatuses have been reduced in size and price in recent years, a new product form has appeared. It is a multifunction color printer in which an image reader unit is disposed above a color image forming apparatus and that also functions as a desktop color copier. In recent years, the need for the multifunction color printer has increased.

However, color image forming apparatuses having the above-described clam shell structure are disadvantageous in that the top door cannot be opened and it is difficult to remove and install the image forming units when there is no large space above the apparatus.

### SUMMARY OF THE INVENTION

The present invention is directed to an image forming apparatus such that the user can open and close an opening and closing unit relative to the main body of the apparatus and remove and install image forming units even when there is no large space above the apparatus.

In an aspect of the present invention, an image forming apparatus includes an image forming unit configured to form an image, a belt facilitating transferring an image formed by the image forming unit onto a recording material, and an opening and closing unit having the belt and openable and closable relative to a main body of the apparatus. The belt is provided above the image forming unit, and the image forming unit is removable from the main body of the apparatus when the opening and closing unit is open. The opening and closing unit slides substantially horizontally, thereby opening and closing relative to the main body of the apparatus.

In another aspect of the present invention, an image forming apparatus includes a plurality of image forming units each configured to form an image, a belt facilitating transferring images formed by the plurality of image forming units onto a recording material, and an opening and closing unit having the belt and openable and closable relative to a main body of the apparatus. The belt is provided above the plurality of image forming units, and the plurality of image forming units are removable from the main body of the apparatus when the opening and closing unit is open. The opening and closing unit slides substantially parallel to the arranging direction of the plurality of image forming units, thereby opening and closing relative to the main body of the apparatus.

Further features of the present invention will become apparent from the following description of exemplary embodiments with reference to the attached drawings.

### BRIEF DESCRIPTION OF THE DRAWINGS

FIG. 1 shows an image forming apparatus according to an embodiment of the present invention.

FIG. 2 is a perspective view of the image forming apparatus.

FIG. 3 shows a belt unit.

FIG. 4 also shows the belt unit.

FIG. 5 shows the image forming apparatus with an opening and closing unit open.

FIG. 6 shows the opening and closing unit.

FIG. 7 shows an image forming portion.

FIGS. 8A and 8B show an engaging portion of the belt unit.

FIG. 9 shows the image forming apparatus with the opening and closing unit open.

FIG. 10 is a perspective view showing the image forming apparatus with the opening and closing unit open.

FIG. 11 shows the engaging portion of the belt unit.

FIG. 12 shows the image forming apparatus with the opening and closing unit open.

FIG. 13 shows an image forming apparatus according to another embodiment of the present invention.

FIGS. 14A and 14B show the image forming apparatus.

FIG. 15 shows a frame of the image forming apparatus.

FIG. 16 is a perspective view of a belt unit.

FIG. 17 shows the belt unit.

FIG. 18 also shows the belt unit.

FIGS. 19A to 19C show the image forming apparatus with its opening and closing unit and fixing unit open.

FIG. 20 is a perspective view showing the fixing unit.

FIG. 21 shows one end of the fixing unit.

FIG. 22 shows one end of the belt unit.

FIG. 23 shows one end of the fixing unit.

FIGS. 24A to 24E show one end of the fixing unit.

FIG. 25 shows the image forming apparatus with the opening and closing unit and fixing unit open.

FIGS. 26A to 26E show one end of the fixing unit.

FIG. 27 shows a conventional image forming apparatus.

### DESCRIPTION OF THE EMBODIMENTS

The embodiments of the present invention will now be described with reference to the drawings.

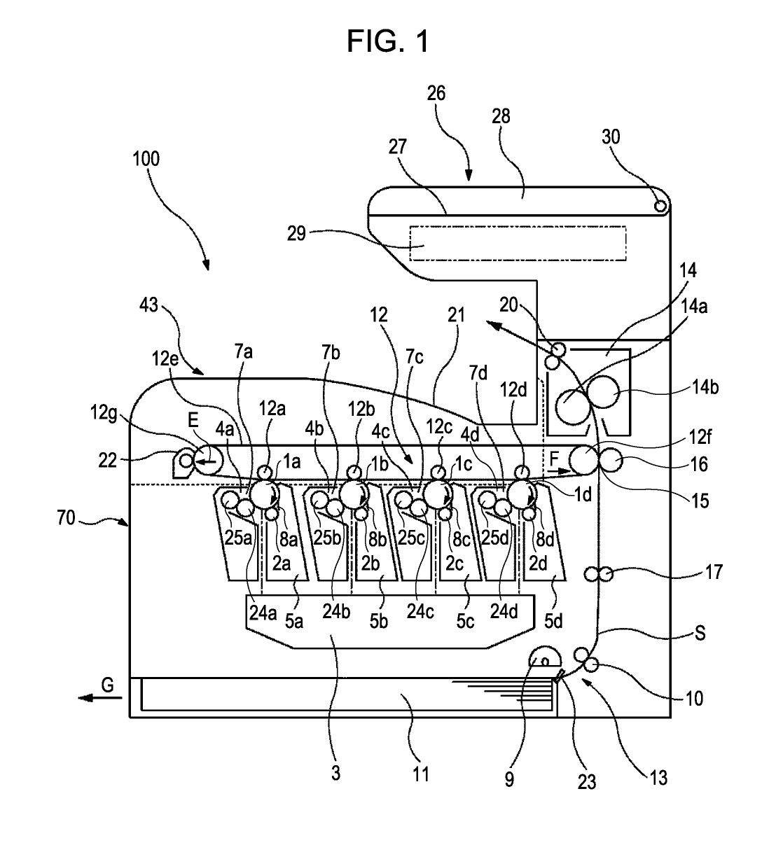

FIG. 1 is a schematic sectional view of an image forming apparatus according to an embodiment of the present invention. First, the overall structure of the image forming apparatus will be described with reference to FIG. 1. FIG. 1 shows a multifunction color laser printer 100, which is a type of image forming apparatus.

The multifunction color laser printer 100 shown in FIG. 1 has process cartridges 7a, 7b, 7c, and 7d, which are image forming units removable from the main body of the apparatus. Although these four process cartridges 7a to 7d have the same structure, they differ in that they form images with different colors toners, that is, yellow (Y), magenta (M), cyan (C), and black (Bk). Each of the process cartridges 7a to 7d has a first unit (4a, 4b, 4c, 4d) and a second unit (5a, 5b, 5c, 5d).

Each of the first units 4a to 4d has a developing roller (24a, 24b, 24c, 24d), a toner application roller (25a, 25b, 25c, 25d), and a toner container.

Each of the second units 5a to 5d has a photosensitive drum (1a, 1b, 1c, 1d), a charging roller (2a, 2b, 2c, 2d), a cleaning blade (8a, 8b, 8c, 8d), and a waste toner container.

A scanner unit 3 is disposed under the process cartridges 7a to 7d. The scanner unit 3 exposes the photosensitive drums 1a to 1d on the basis of an image signal.

The charging rollers 2a to 2d charge the photosensitive drums 1a to 1d, respectively, at a predetermined negative potential. Thereafter, the scanner unit 3 forms electrostatic latent images on the photosensitive drums 1a to 1d. The electrostatic latent images are reversal-developed by the first units 4a to 4d. Negatively charged toners are attached to the electrostatic latent images. In this way, Y, M, C, and Bk toner images are formed.

A belt unit 12 includes an intermediate transfer belt 12e, a driving roller 12f, a tension roller 12g, and primary transfer rollers 12a, 12b, 12c, and 12d, which are opposite to the photosensitive drums 1a to 1d and inside the intermediate transfer belt 12e.

The intermediate transfer belt 12e is stretched around the driving roller 12f and the tension roller 12g. The tension roller 12g provides a tension to the intermediate transfer belt 12e in the direction of arrow E. Transfer biases are applied to the primary transfer rollers 12a to 12d by bias application units (not shown). The intermediate transfer belt 12e is provided above the process cartridges 7a to 7d.

Each photosensitive drum rotates in the arrow direction. The intermediate transfer belt 12e moves in the direction of arrow F. Positive biases are applied to the primary transfer rollers 12a to 12d.

In sequence from the photosensitive drum 1a to the photosensitive drum 1d, toner images on the photosensitive drums are primary-transferred onto the intermediate transfer belt 12e. The four colors of toner images are conveyed in a superposed state to a secondary transfer portion 15.

A feeding unit 13 includes a feeding roller 9 and a conveying roller pair 10. A paper cassette 11 contains sheets S (recording materials). The feeding roller 9 picks up a sheet S from the paper cassette 11. The conveying roller pair 10 conveys the fed sheet S.

The paper cassette 11 can be pulled out in the direction of arrow G in FIG. 1. The user pulls the paper cassette 11 out of the main body of the apparatus, loads sheets S into the paper cassette 11, and sets the paper cassette 11 into the main body of the apparatus.

The sheets S contained in the paper cassette 11 are pressed against the feeding roller 9, separated by a separating pad 23 one at a time (friction piece separation method), and conveyed.

The sheet S conveyed from the feeding unit 13 is temporarily stopped by a registration roller pair 17 and thereafter conveyed to the secondary transfer portion 15.

In the secondary transfer portion 15, a positive bias is applied to a secondary transfer roller 16, and thereby the four colors of toner images on the intermediate transfer belt 12e are secondary-transferred onto the sheet S conveyed to the secondary transfer portion 15.

The sheet S onto which the toner images are transferred is conveyed to a fixing device 14 and heated and pressed by a fixing roller 14a and a pressing roller 14b, and thereby the toner images are fixed to the surface of the sheet. Thereafter, the sheet S is output onto an output tray 21 (output portion) by an output roller pair 20.

After the transfer of toner images, toners remaining on the surfaces of the photosensitive drums 1a to 1d are removed by the cleaning blades 8a to 8d. Toners remaining on the intermediate transfer belt 12e after the secondary transfer onto the sheet S are removed by a belt cleaning unit 22. The removed toners are conveyed through a waste toner conveying path (not shown) and put in the waste toner container (not shown) disposed at the back of the apparatus.

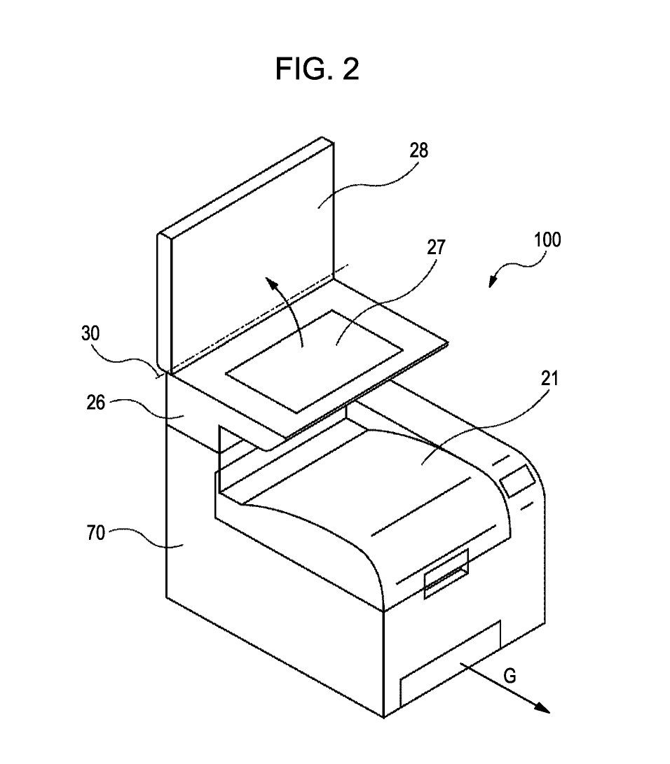

As shown in FIGS. 1 and 2, an image reader unit 26 is disposed at the top of the multifunction color laser printer 100. That is, the image reader unit 26 is provided above the printing portion 70 (image forming portion), and the image reader unit 26 is disposed above a below-described opening and closing unit 43. The image reader unit 26 includes a document plate 27 on which a document is placed, a document presser 28 that presses the document, and a reader 29 that reads the image information of the document.

The reader 29 includes a light source that irradiates the surface of the document with light, a mirror that deflects light reflected by the surface of the document, a lens that converges light from the mirror, and a CCD sensor that detects light converged by the lens and generates an image data signal corresponding to the document image.

The document presser 28 is disposed on the top of the document plate 27 and is rotatable around a rotation fulcrum 30 provided at one end of the document plate 27.

The user opens the document presser 28 to the position of FIG. 2, places a document on the document plate 27, and closes the document presser 28.

The multifunction color laser printer 100 reads and digitizes the image information with the above-described reader 29, generates a toner image on the basis of the image data, and transfers the toner image onto a sheet, thereby copying a color image.

The left side in FIG. 1 of the multifunction color laser printer 100 is the front of the apparatus. The user can place a document on the document plate 27 and load sheets into the paper cassette 11 from the front of the apparatus.

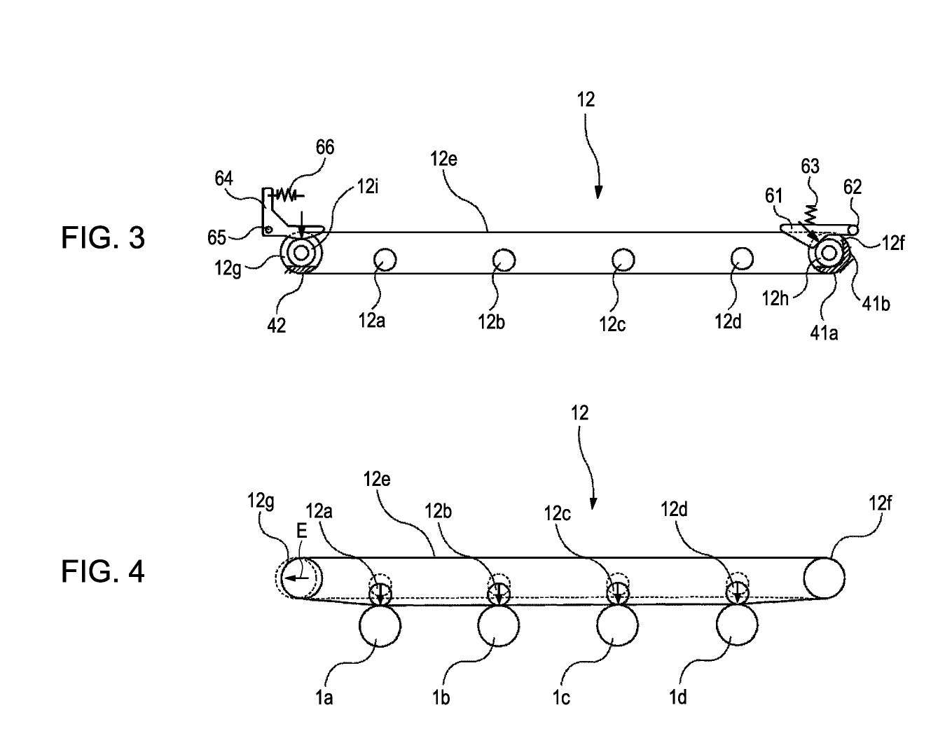

Next, positioning and operation during image formation of the intermediate transfer belt 12e, the primary transfer rollers 12a to 12d, the driving roller 12f, the tension roller 12g, and so forth of the belt unit 12, which characterizes the present invention, will be described with reference to FIGS. 3 and 4.

FIG. 3 shows the state of the intermediate transfer belt 12e in the main body of the apparatus.

The intermediate transfer belt 12e is stretched around the driving roller 12f and the tension roller 12g. Bearings 12h are attached to each end of the driving roller 12f rotatably relative to the roller 12f. Bearings 12i are attached to each end of the tension roller 12g rotatably relative to the roller 12g. To reduce the sliding resistance, ball bearings are used as the bearings 12h and 12i. The outer circumferential surfaces of the bearings 12h are pressed against positioning surfaces 41a and 41b formed in the main body of the apparatus, thereby being positioned. The outer circumferential surfaces of the bearings 12i are pressed against positioning surfaces 42 formed in the main body of the apparatus, thereby being positioned. Pressing levers 61 are disposed in the main body of the apparatus so as to be able to come into contact with the outer circumferential surfaces of the bearings 12h. The pressing levers 61 are supported rotatably around rotation shafts 62. Pressed by compression springs 63 from above, the levers 61 press the bearings 12h in the direction of the arrow. In this way, the driving roller 12f is positioned vertically and horizontally.

Pressing levers 64 are disposed in the main body of the apparatus so as to be able to come into contact with the bearings 12i. The pressing levers 64 are supported rotatably around the rotation shafts 65 like the pressing levers 61. Due to tension springs 66 disposed above the levers 64, the levers 64 generate clockwise (in the figure) torque and downward press the bearings 12i. In this way, the tension roller 12g is positioned vertically.

As described above, the positions of the driving roller 12f and the tension roller 12g are determined, and the intermediate transfer belt 12e stretched around them is positioned.

Except during image formation, the primary transfer rollers 12a to 12d are separated from the intermediate transfer belt 12e as shown in FIG. 3.

The primary transfer rollers 12a to 12d are rotatably supported by base members that serve as bases of the belt unit 12. The primary transfer rollers 12a to 12d are always urged by an urging unit (not shown) toward the intermediate transfer belt 12e (downward in the figure). In FIG. 3, a separating member (not shown) is retracting the primary transfer rollers 12a to 12d from the intermediate transfer belt 12e against the urging unit.

By virtue of the above-described structure, the belt unit 12 is accurately positioned relative to the main body of the apparatus, and the intermediate transfer belt 12e and the primary transfer rollers 12a to 12d are supported in the main body of the apparatus, separated from each other except during image formation.

Next, the state of the belt unit 12 during image formation will be described with reference to FIG. 4. When the apparatus enters the image formation mode, the separating member (not shown) is released, and the primary transfer rollers 12a to 12d are pressed against the photosensitive drums 1a to 1d by the urging unit (not shown) with the intermediate transfer belt 12e therebetween. In this state, high voltages are applied to the primary transfer rollers 12a to 12d so that toner images on the photosensitive drums 1a to 1d can be transferred onto the intermediate transfer belt 12e.

Tension force E always acts on the tension roller 12g. The tension roller 12g moves horizontally in the figure so as to maintain the tension of the intermediate transfer belt 12e.

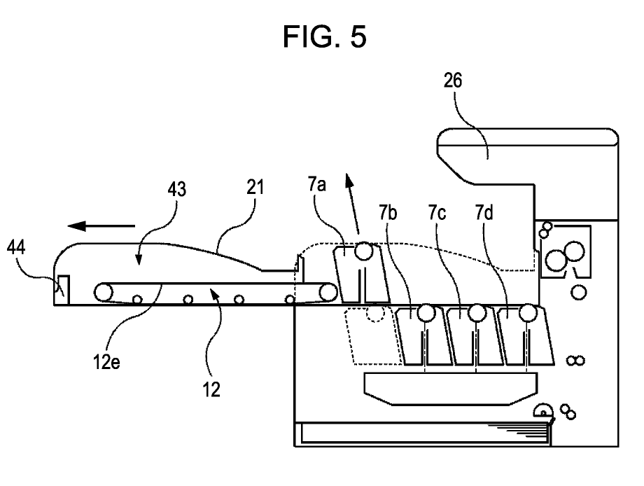

Next, how the opening and closing unit 43 is retracted and how to replace the process cartridges 7a to 7d will be described with reference to FIG. 5.

FIG. 5 is a sectional view of the multifunction color laser printer 100 and shows the removal of the process cartridge 7a. As shown in FIG. 5, the opening and closing unit 43 is slidable leftward in the figure (forward). That is, the opening and closing unit 43 including the belt unit 12 slides horizontally, thereby being openable and closable relative to the main body of the apparatus.

The opening and closing unit 43 mainly includes the above-described belt unit 12, a handle portion 44, and a cover having the output tray 21.

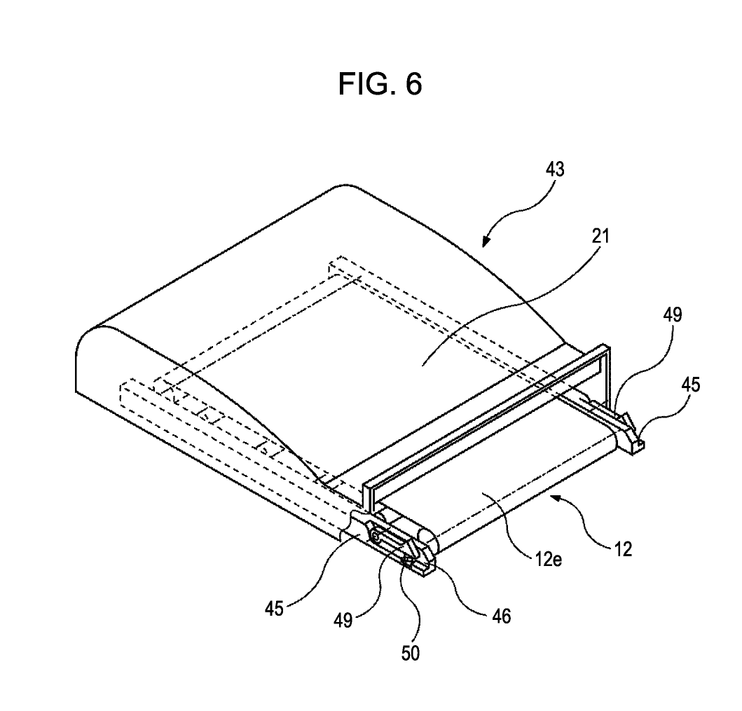

As shown in FIG. 6, rail members 45 are disposed at each end of the opening and closing unit 43 (each end in a direction perpendicular to the sliding direction) so that the unit 43 can smoothly slide relative to the main body of the apparatus. How the opening and closing unit 43 is pulled out will hereinafter be described.

As described above, the photosensitive drums 1a to 1d and the intermediate transfer belt 12e are separated from each other except during image formation. Therefore, when the opening and closing unit 43 is pulled out, the surfaces of the photosensitive drums 1a to 1d and the intermediate transfer belt 12e are not damaged.

The opening and closing unit 43 is slidable leftward in FIG. 5, that is, in the same direction as the direction in which printouts are output from the apparatus.

Therefore, even though the image reader unit 26 is disposed at the top of the apparatus, the visibility and accessibility of the output portion are excellent. Since the opening and closing unit 43 is pulled out away from the sheet path, components relating to sheet conveyance can be disposed in a fixed state, and therefore reliability in sheet conveyance is maintained.

Next, the actual user operation will be described. The user first grasps the handle portion 44 and pulls out the opening and closing unit 43 to access the process cartridges 7a to 7d. At this time, the opening and closing unit 43 is pulled out against the urging force (spring force of the compression spring 63) that presses and positions the belt unit 12. Although the user feels some load, the load is reduced to an acceptable level by forming the pressing levers 61 of highly slidable material and/or by inclining the sliding surfaces.

Thereafter, the process cartridges 7a to 7d are exposed, and the user can take the process cartridges 7a to 7d out of the space opened by the forward movement of the belt unit 12.

The process cartridges 7a to 7d are parallelogram in cross section so as to be easily removed and installed from the front of the apparatus. A guide member (not shown) formed in the main body of the apparatus guides the process cartridges 7a to 7d so that the process cartridges 7a to 7d can be smoothly removed and installed. The process cartridges 7a to 7d are pulled out upward and obliquely forward.

Such a structure enables the user to easily replace the process cartridges 7a to 7d without retracting the image reader unit 26 located at the top of the product. In addition, such a structure can eliminate the increase in cost due to retraction of the image reader unit and the increase in weight due to the increase in the number of components for reinforcement in the case where the image reader unit is movable.

Horizontal arrangement of the plurality of photosensitive drums 1a to 1d reduces the height of the apparatus and therefore the height of the output portion, thereby improving accessibility to the output portion. When the apparatus is installed on a desktop, the height of the document surface can be set to an acceptable value or less. Thus, the problem of the height of the document surface can be solved.

Since the opening and closing unit 43 having the output tray 21 is slidable, the user can replace the process cartridges 7a to 7d with output sheets on the tray. In the conventional clam shell structure, sheets on the tray need to be temporarily removed. The need is eliminated and the usability is improved.

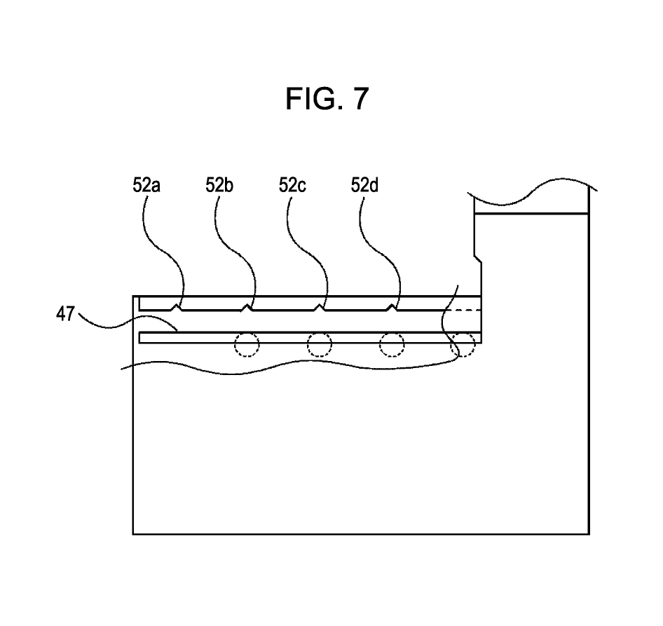

Next, the sliding mechanism and clicking mechanism of the opening and closing unit 43 will be described with reference to FIGS. 6 and 7. FIG. 6 is a perspective view of the opening and closing unit 43. FIG. 7 is a partial sectional view of the main body of the apparatus. The rail members 45 are attached to each end of the belt unit 12 in the opening and closing unit 43. The rail members 45 are formed of resin having high slidability and elongate in the sliding direction. Each rail member 45 has a depression 46 at one end thereof.

As shown in FIG. 7, the main body of the apparatus has grooves 47 in which the rail members 45 are to be fitted. The grooves 47 are formed in each inner side surface of the main body of the apparatus. Fitting the rail members 45 in the grooves 47 enables the opening and closing unit 43 to smoothly slide horizontally in FIG. 7.

As described above, the belt unit 12 is positioned by the driving roller 12f and the tension roller 12g. That is, when the opening and closing unit 43 is set in the main body of the apparatus, clearance is provided between the rail members 45 and the grooves 47 to prevent contact.

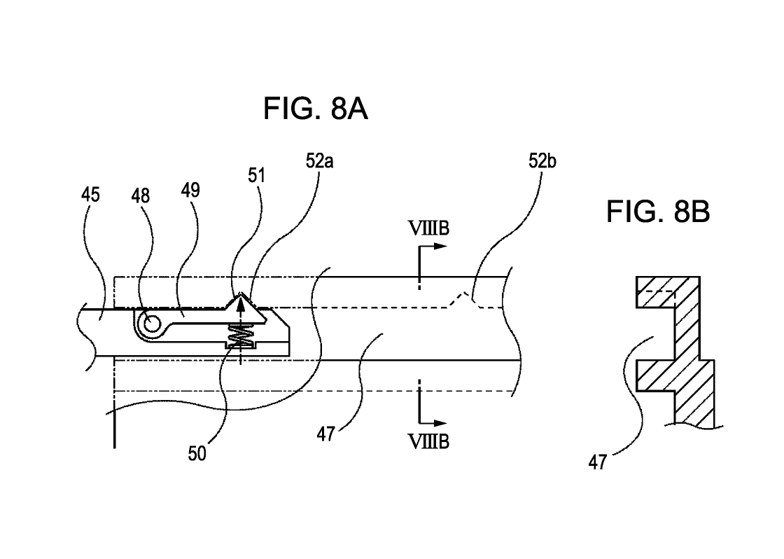

Next, the clicking mechanism will be described with reference to FIGS. 8A and 8B. FIG. 8A is an enlarged view of one end of one of the rail members 45. In the depression 46, a cylindrical portion 48 is formed integrally with the rail member 45. The cylindrical portion 48 is fitted in a lever member 49, which is rotatable around the cylindrical portion 48. The lever member 49 can be formed of polyacetal resin, which has high slidability. The lever member 49 has a triangular protrusion 51 formed in the upper part thereof.

A compression spring 50 is disposed under the lever member 49 so as to press the lever member 49 in the direction of an arrow in the figure. That is, the lever member 49 is urged counterclockwise around the cylindrical portion 48.

Triangular notches 52a, 52b, 52c, and 52d are provided at predetermined positions in the inner surface of the corresponding groove 47 of the main body of the apparatus.

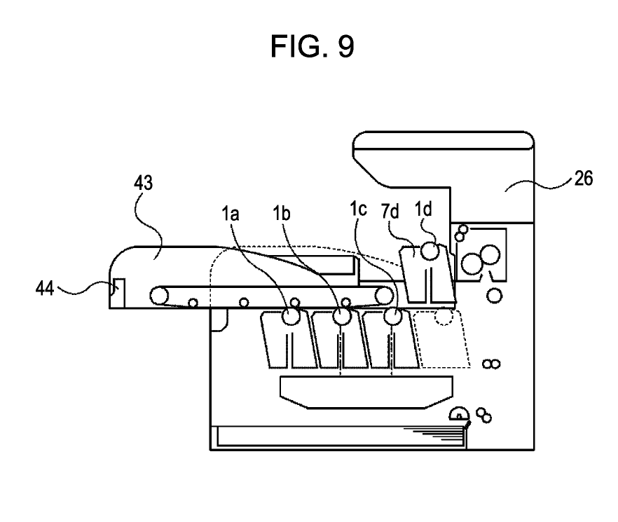

The user grasps the handle portion 44 and pulls out the opening and closing unit 43. The triangular protrusion 51 is engaged with the triangular notch 52d and gives the user a clicking sensation. At this time, the backmost process cartridge 7d is completely exposed as shown in FIG. 9.

The positions of the triangular notches 52a, 52b, 52c, and 52d correspond to the positions of the process cartridges 7a, 7b, 7c, and 7d, respectively. When the user replaces the backmost process cartridge 7d, the user does not have to fully pull out the opening and closing unit 43. The user only has to pull out the opening and closing unit 43 to the position shown in FIGS. 9 and 10. The user can replace the process cartridge 7d despite the image reader unit 26 above.

In FIGS. 9 and 10, the other process cartridges 7a, 7b, and 7c are covered by the opening and closing unit 43. Therefore, if the user drops the removed process cartridge 7d, the photosensitive drums 1a, 1b, and 1c are protected. That is, the user is prevented from accidentally damaging the photosensitive drums 1a, 1b, and 1c.

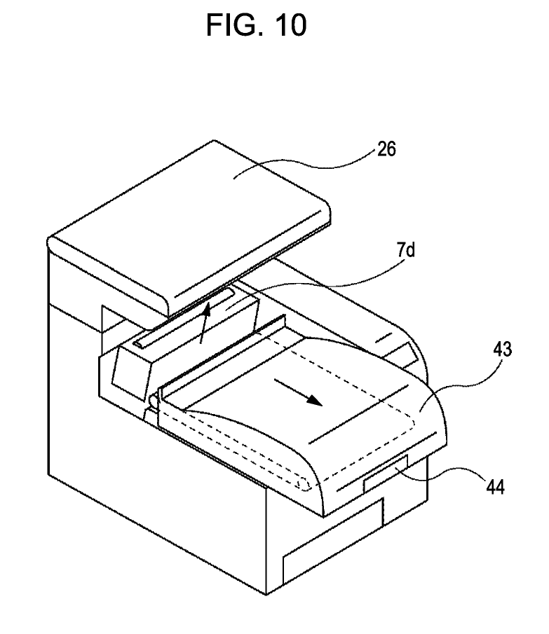

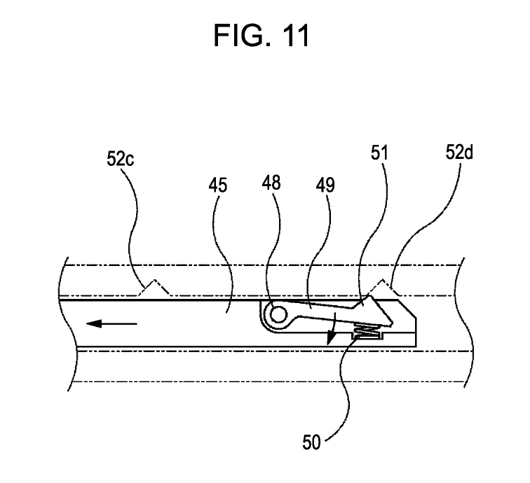

From the state of FIG. 9, the user grasps the handle portion 44 and further pulls out the opening and closing unit 43. As shown in FIG. 11, the lever member 49 rotates clockwise against the force of the compression spring 50. The triangular protrusion 51 is disengaged from the triangular notch 52d, thereby enabling the opening and closing unit 43 to smoothly slide. Next, the triangular protrusion 51 is engaged with the triangular notch 52c, thereby giving the user a clicking sensation. At this time, the second backmost process cartridge 7c is exposed and can be removed.

As described above, setting the retracted positions of the opening and closing unit 43 in accordance with the positions of the process cartridges enables the above-described protection of the photosensitive drums. In addition, the distance from the user to the process cartridge to be replaced can be kept constant, and the user can easily replace even the backmost process cartridge.

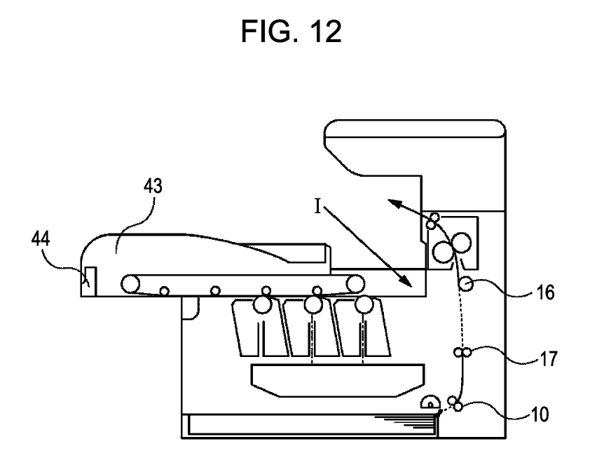

Next, a method to remove jammed paper from the multifunction color laser printer 100 will be described with reference to FIG. 12. FIG. 12 is a vertical sectional view of the multifunction color laser printer 100 with the triangular protrusion 51 engaged with the triangular notch 52d.

The user removes the process cartridge 7d, thereby completely exposing the sheet conveyance portion. The user can observe the conveying roller pair 10, the registration roller pair 17, and the secondary transfer roller 16 from the direction of arrow I in FIG. 12, can easily know where the jammed sheet is, and can remove the sheet.

Since the opening and closing unit slides horizontally to open and close relative to the main body of the apparatus in this embodiment, the user can open and close the opening and closing unit 43 relative to the main body of the apparatus and can remove and install the image forming units even when there is no large space above the apparatus.

The horizontal sliding of the opening and closing unit is effective particularly in apparatuses in which a document reader unit is disposed above the opening and closing unit like this embodiment because interference between the opening and closing unit and the document reader unit can be avoided.

In this embodiment, the opening and closing unit 43 has the output portion on which recording materials output from the main body of the apparatus are placed. Since the opening and closing unit 43 slides horizontally, the user does not have to remove sheets on the output portion before opening the opening and closing unit 43. This improves the operability.

Since the plurality of image forming units are arranged in the sliding direction of the opening and closing unit, the user only has to move the opening and closing unit by a distance needed for removing and installing a desired image forming unit. This further improves the operability. That is, since the opening and closing unit can slide substantially parallel to the arranging direction of the plurality of image forming units, the user only has to slide the opening and closing unit by a distance needed for removing and installing a desired image forming unit.

In this embodiment, the user can load sheets of paper into the paper cassette, place a document, replace process cartridges, and remove jammed paper from the front of the apparatus. This improves the operability.

In this embodiment, the height of the apparatus can be reduced by horizontally arranging the plurality of photosensitive drums. In consideration of installation on a desktop, the height of the document surface can be limited to an acceptable value or less.

In this embodiment, the paper cassette is pulled out and set from the front of the apparatus, and the direction in which the opening and closing unit is moved is the same as the direction in which the paper cassette is pulled out and set. Alternatively, the opening and closing unit may be slid horizontally in a direction perpendicular to the direction in which sheets are conveyed, that is, in a lateral direction of the main body of the apparatus. Also in this case, the user can replace the process cartridges without retracting the image reader unit. In addition, since the moved opening and closing unit 43 is not located between the user and the process cartridges, the distance from the user to the process cartridges can be set small, and the workability in replacement of the process cartridges is improved.

Alternatively, it is possible to pull out and set the paper cassette in a direction perpendicular to the direction in which sheets are conveyed, and to move the opening and closing unit in a direction perpendicular to the direction in which the paper cassette is pulled out and set, that is, from the front of the main body of the apparatus. What is important is to horizontally move the opening and closing unit to remove and install the process cartridges. This can provide a multifunction printer whose image reader unit need not be retracted.

Although the opening and closing unit is horizontally slid in the above-described embodiment, the sliding direction only has to be substantially horizontal and can be slightly inclined.

This embodiment enables the user to replace the image forming units without retracting the image reader unit disposed in the upper part of the apparatus. Therefore, the image reader unit, which is heavy, need not be movable, and the user does not have to open and close the image reader unit. Since the image reader unit, which is required to be accurate, is immovably supported, the apparatus has a simple structure and high reliability.

Apparatuses having a rotatable image reader unit need components for reinforcing the vicinity of the rotation fulcrum and/or components for maintaining weight balance when the image reader unit is open, whereas this embodiment does not need such components and therefore the cost and weight can be held down.

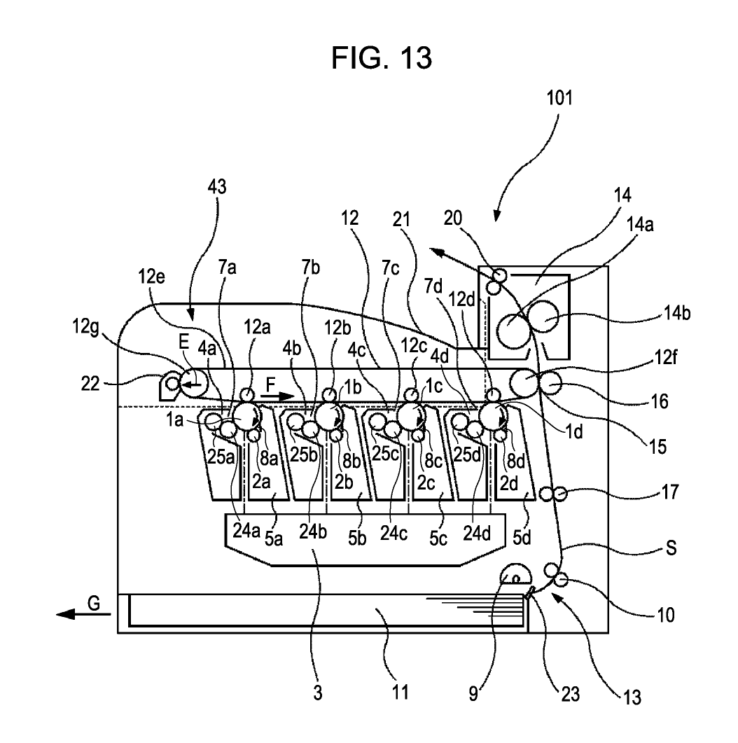

Next, another embodiment of the present invention will be described. FIG. 13 is a vertical sectional view showing the overall structure of a color laser beam printer 101, which is a type of image forming apparatus to which the present invention is applied. This embodiment has the same basic structure as the above-described embodiment except that this embodiment has no document reading unit. The difference will mainly be described.

As shown in FIG. 13, the Bk process cartridge 7d of the image forming apparatus of this embodiment is nearer to the fixing device 14 in the horizontal direction as compared to the Bk process cartridge 7d of the image forming apparatus of the above-described embodiment. Therefore, the depth of the apparatus of this embodiment is smaller than that of the above-described embodiment.

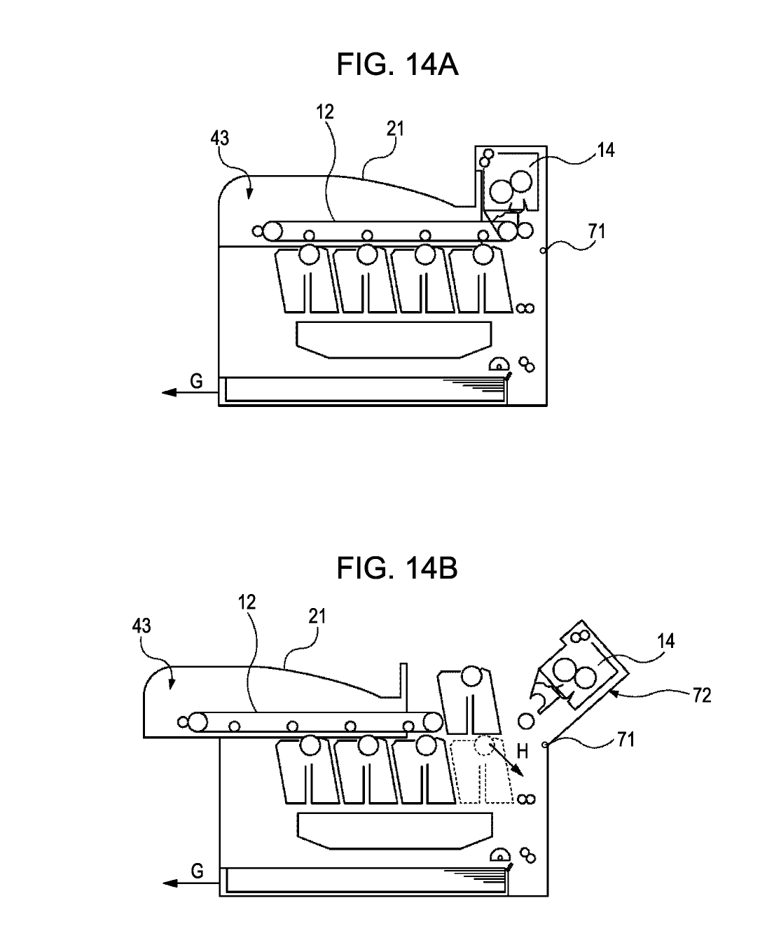

As shown in FIGS. 14A and 14B, the opening and closing unit 43 slides together with the output tray 21 forward (leftward in the figures) by a sliding mechanism (not shown) provided in the main body. The fixing device 14 disposed above the Bk cartridge 7d is unitized with a cover so as to form a fixing unit 72. The fixing unit 72 rotates upward and backward (rightward in the figures) around a rotation fulcrum 71 of the main body of the apparatus so as to expose the secondary transfer portion 15.

The fixing unit 72 rotates by an angle such that a space necessary to replace the Bk cartridge 7d and a space necessary to remove jammed paper are formed. That is, the fixing unit 72 is openable and closable relative to the main body of the apparatus. The fixing unit 72 overlaps at least part of one of the image forming units as viewed in a vertical direction.

The paper cassette 11 is pulled out in the direction of arrow G. The user can replace the cartridge and remove jammed paper from the direction of arrow H, that is, from the front of the main body of the apparatus (the left in the figures).

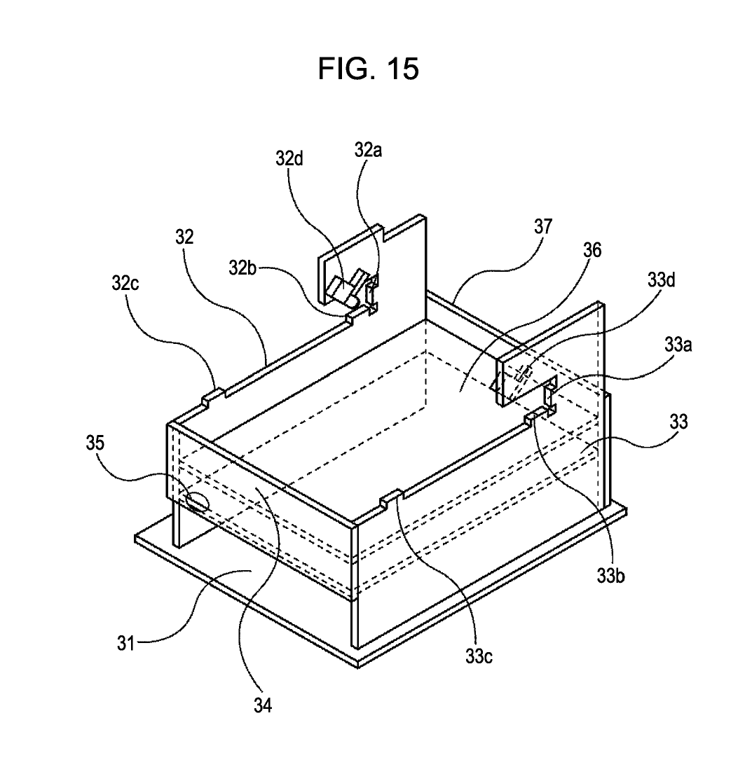

Next, the frame structure of the image forming apparatus 101 will be described with reference to FIG. 15. The frame of the image forming apparatus 101 includes a left side plate 32 and a right side plate 33 disposed on a bottom plate 31, and a front stay 34, a lower stay 35, a middle stay 36, and a rear stay 37 disposed so as to link the left and right side plates 32 and 33.

The lower stay 35 separates the paper cassette 11 from the scanner unit 3. The middle stay 36 separates the scanner unit 3 from the process cartridges 7a to 7d. The middle stay 36 has a slit (not shown) through which laser light from the scanner unit 3 passes.

The left side plate 32 has protrusions 32a, 32b, and 32c and the right side plate 33 has protrusions 33a, 33b, and 33c for positioning the belt unit. Below-described pressing members 32d and 33d are screwed to the left and right side plates 32 and 33, respectively.

The above-described frame components are joined with screws (not shown). The four stays and the left and right side plates form a box shape, thereby improving the stiffness of the whole frame.

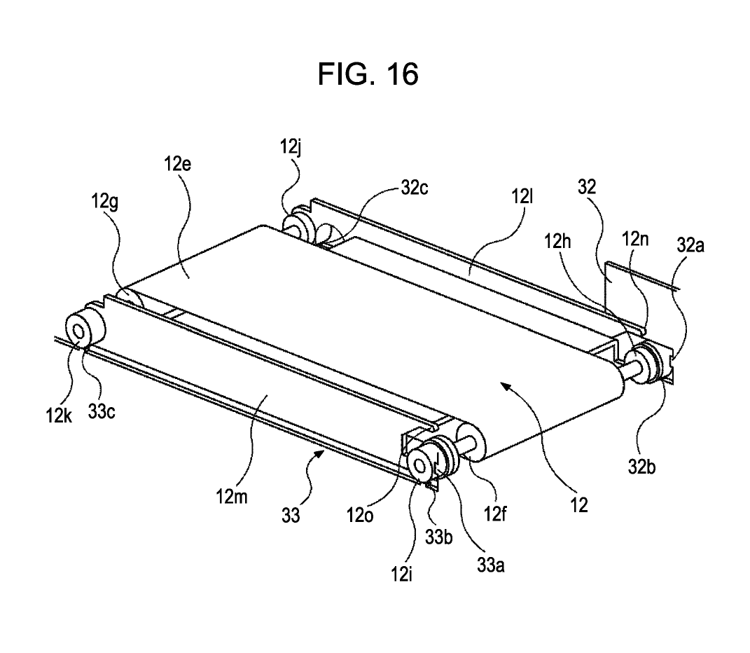

How the belt unit 12 is positioned in the main body of the apparatus will be described with reference to FIG. 16.

As shown in FIG. 16, the bearing 12h of the driving roller 12f is pressed against the protrusions 32a and 32b of the left side plate 32 by a pressing member 32d (see FIG. 15), and the bearing 12i of the driving roller 12f is pressed against the protrusions 33a and 33b of the right side plate 33 by a pressing member 33d (see FIG. 15). The driving roller 12f also functions as a secondary transfer opposing roller. The pressing members 32d and 33d are fixed to the left and right side plates 32 and 33, respectively. The bearing 12j of the tension roller 12g is pressed against the protrusion 32c of the left side plate 32 by a pressing member (not shown), and the bearing 12k of the tension roller 12g is pressed against the protrusion 33c of the right side plate 33 by a pressing member (not shown). In this way, the belt unit 12 is positioned in the main body of the apparatus.

Casings 12l and 12m link the driving roller 12f and the tension roller 12g. The casing 12l has a rib 12n formed at one end thereof. The casing 12m has a rib 12o formed at one end thereof.

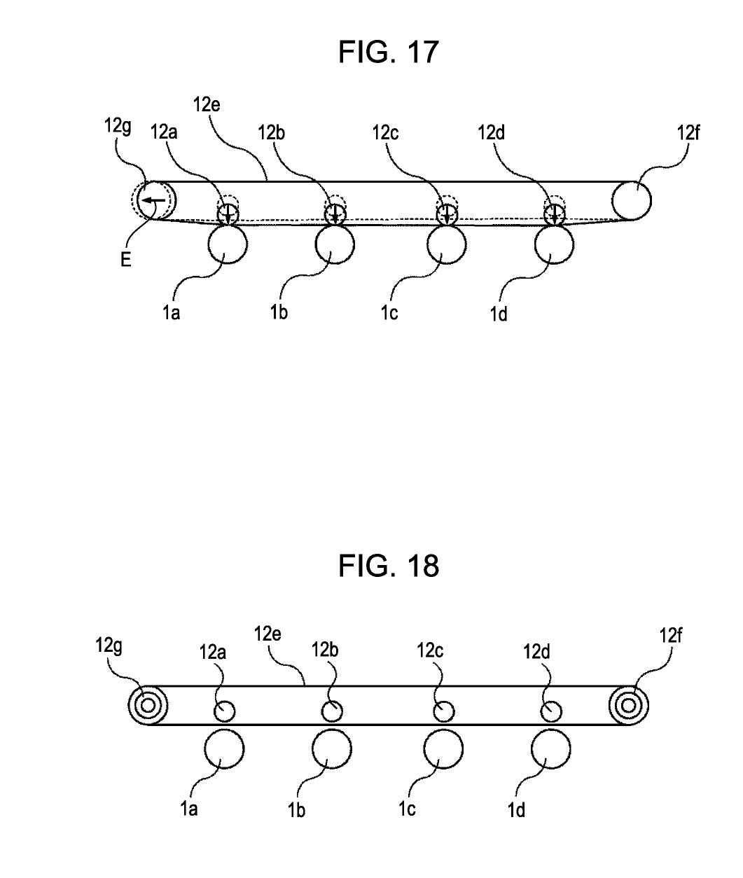

As shown in FIG. 17, during printing operation, the primary transfer rollers 12a to 12d of the belt unit 12, urged by pressing springs (not shown), bring the intermediate transfer belt 12e into contact with the photosensitive drums 1a to 1d. Toner images on the photosensitive drums 1a to 1d are sequentially transferred onto the intermediate transfer belt 12e.

As shown in FIG. 18, when the printing operation is completed or when paper is jammed, the primary transfer rollers 12a to 12d are separated and retracted from the photosensitive drums 1a to 1d by a separating mechanism (not shown) provided in the belt unit 12.

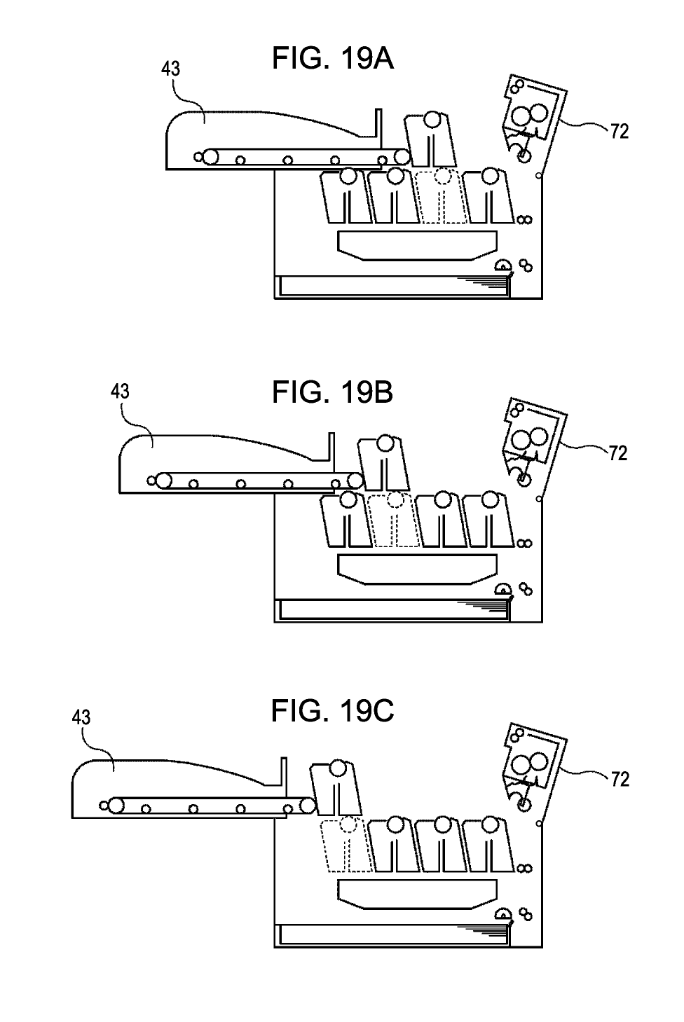

As shown in FIGS. 19A to 19C, the belt unit 12 is slidable forward (leftward in the figures) along rails provided in the main body of the apparatus, with the primary transfer rollers 12a to 12d separated and retracted. That is, the belt unit 12 is slidable when the cartridges are replaced or jammed paper is removed. The belt unit 12 is stoppable at any position as shown in FIGS. 19A, 19B, and 19C. The user only has to slide the belt unit 12 by a distance such that the user can access the cartridge to be replaced. Therefore, the distance from the user to the cartridge to be replaced is constant.

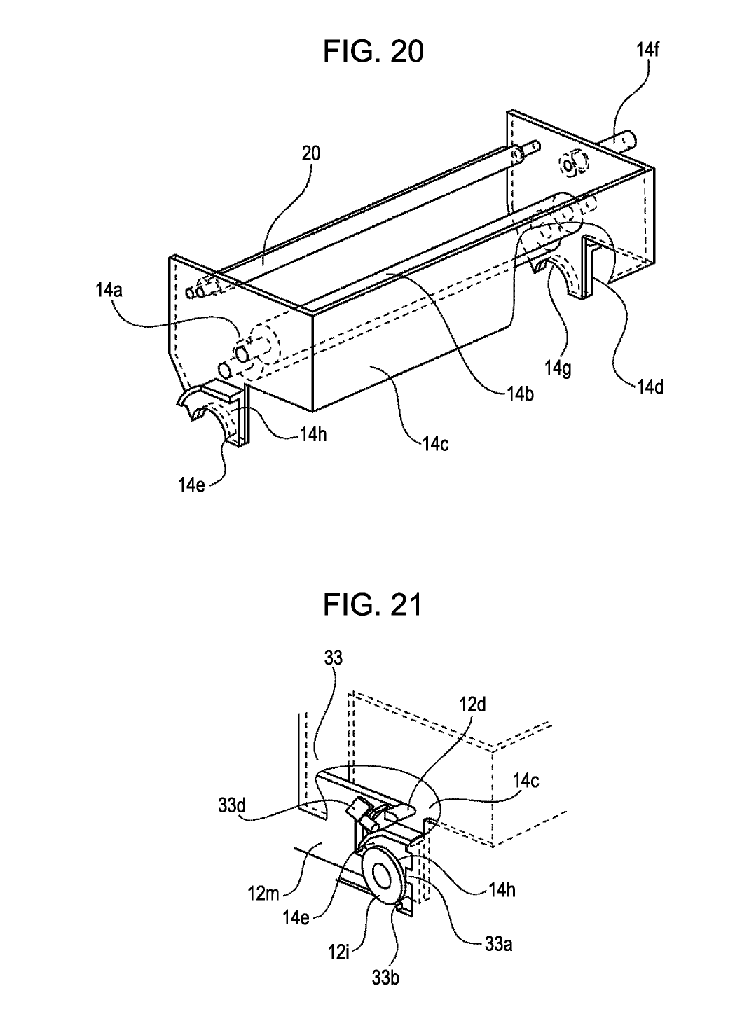

As shown in FIG. 20, the fixing unit 72 includes a fixing frame 14c, a fixing roller 14a, a pressing roller 14b, and an output roller pair 20. The fixing frame 14c has U-shaped portions 14g and 14h formed on either side thereof. Pressing blocks 14d and 14e are screwed to the fixing frame 14c. A gear shaft 14f that transmits drive is attached by caulking to the right side in the figure of the fixing frame 14c.

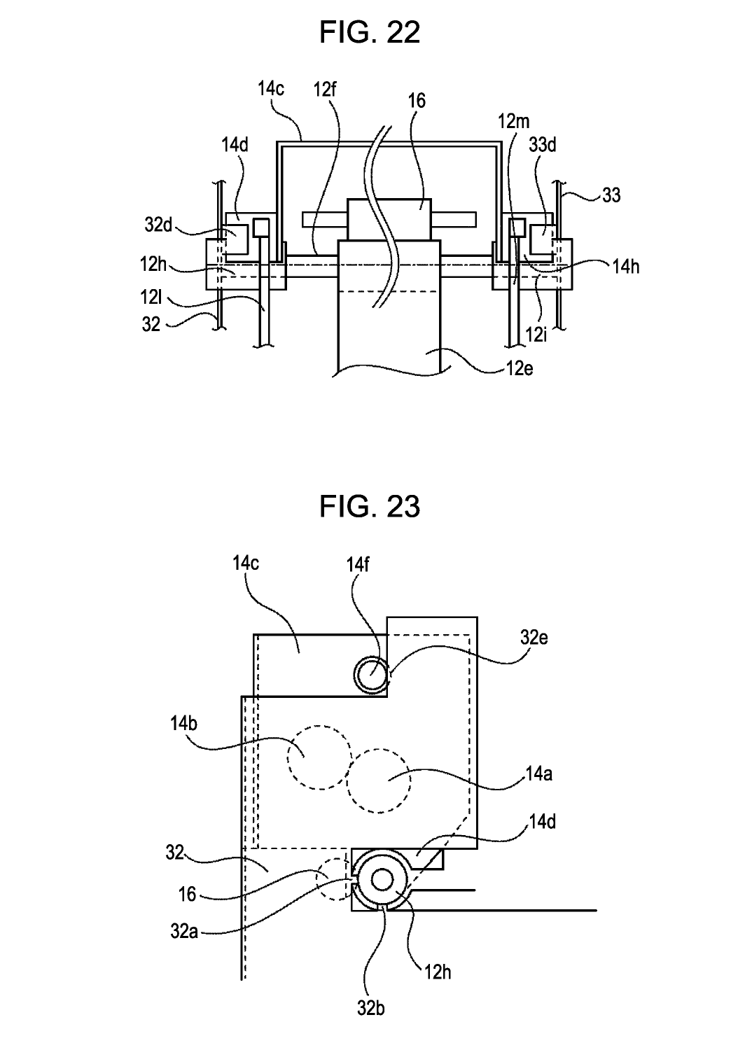

FIG. 21 shows how the fixing unit 72 is positioned in the main body of the apparatus as viewed from the right side plate 33. FIG. 22 shows the positional relationship among components in the sheet-width direction (a direction perpendicular to the direction in which sheets are conveyed). As shown in FIG. 22, the arrangement of components on the side of the left side plate 32 is symmetrical to that on the side of the right side plate 33. Positioning is performed in the same manner on both sides.

First, the U-shaped portion 14h of the fixing frame 14c of the fixing unit 72 is pressed against the bearing 12i of the driving roller 12f of the belt unit 12. Next, as shown in FIG. 23, the gear shaft 14f attached by caulking to the fixing frame 14c is pressed against an abutment surface 32e of the left side plate 32. By pressing three places, the U-shaped portions 14g and 14h and the gear shaft 14f, against the main body, the fixing unit 72 is positioned in the main body. When drive is transmitted to the fixing unit 72, a force is exerted on the gear shaft 14f in the direction of the abutment surface 32e of the left side plate 32, and therefore the gear shaft 14f is firmly pressed against the abutment surface 32e.

As shown in FIG. 21, the pressing member 33d of the right side plate 33 presses the pressing block 14e of the fixing unit 72, thereby pressing the U-shaped portion 14h of the fixing frame 14c against the bearing 12i of the driving roller 12f. The bearing 12i of the driving roller 12f is pressed against the protrusions 33a and 33b of the right side plate 33. In this way, the fixing unit 72 is firmly positioned in the belt unit 12 and the main body.

At the rotation fulcrum 71, a predetermined clearance is provided between the fixing unit 72 and the main body of the apparatus. The positioning of the fixing unit 72 in the main body of the apparatus is performed only at the above-described three places.

As described above, the fixing unit 72 rotates backward around the rotation fulcrum 71 of the main body so as to expose the secondary transfer portion 15. By virtue of such a structure, the user can replace the Bk cartridge and remove jammed paper easily and from the front of the main body.

In addition, by virtue of the above-described structure, the Bk cartridge can be replaced even when the fixing unit 72 is disposed above the Bk cartridge, and therefore the depth of the main body of the apparatus can be reduced.

Next, the interlocking mechanism between the belt unit 12 and the fixing unit 72 will be described in detail, taking the side of the right side plate 33 as an example. As described above, the side of the left side plate 32 has the same structure as the side of the right side plate 33.

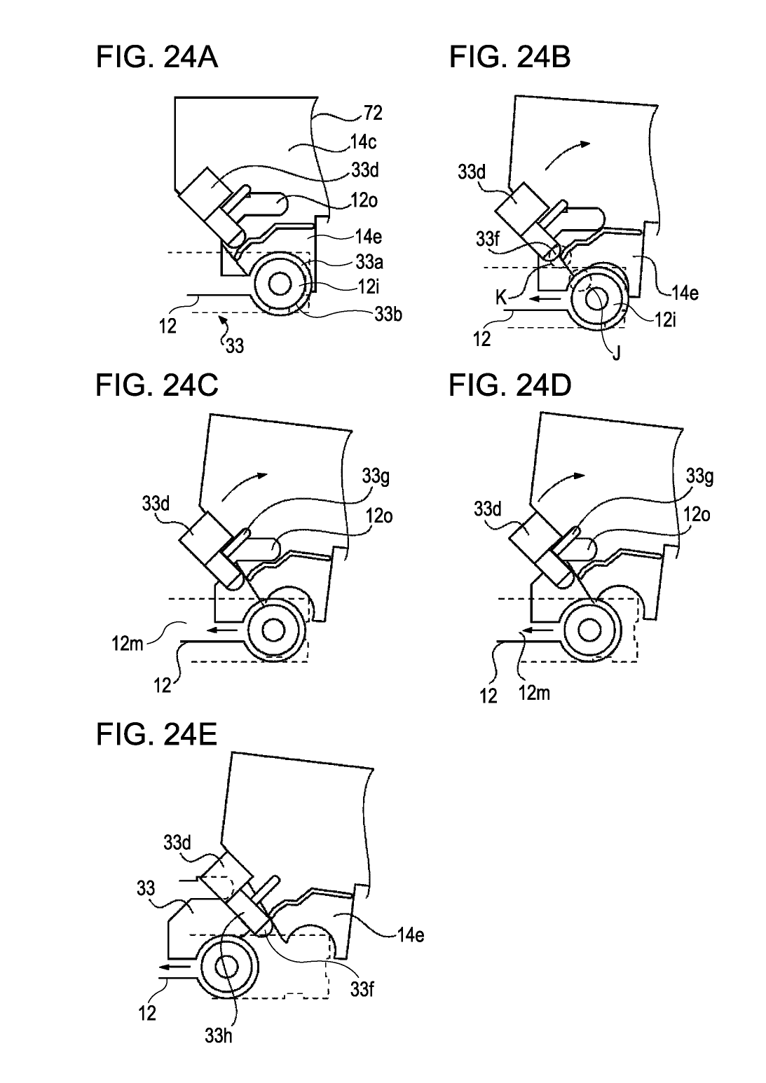

FIGS. 24A to 24E show in sequence how the mechanism operates when the belt unit 12 is pulled out of the main body.

In FIG. 24A, the belt unit 12 and the fixing unit 72 are positioned in the main body. That is, the pressing member 33d fixed to the right side plate 33 presses the pressing block 14e fixed to the fixing frame 14c, thereby pressing the fixing frame 14c against the bearing 12i. The bearing 12i is pressed against the protrusions 33a and 33b of the right side plate 33.

As shown in FIG. 24B, the bearing 12i of the belt unit 12 sliding forward (leftward in the figure) pushes up the pressing block 14e at the point J, thereby clockwise rotating the fixing unit 72. At this time, a lever portion 33f of the pressing member 33d, which has a spring therein, is pushed up and retracted by the pressing block 14e at the point K.

When the belt unit 12 is at the positions of FIGS. 24C and 24D, a boss 33g of the pressing member 33d passes over the rib 12o of the casing 12m, thereby retracting.

As shown in FIG. 24E, after the belt unit 12 slides by a predetermined distance, the lever portion 33f of the pressing member 33d prevents the pressing block 14e from rotating counterclockwise in a cut out portion 33h of the right side plate 33. In this way, the fixing unit 72 is stopped at its retracted position. The retracted position of the fixing unit 72 is a position such that the Bk cartridge can be easily replaced.

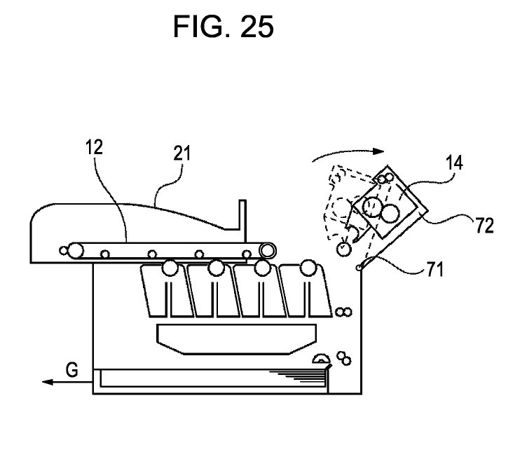

In FIG. 25, the user opens the fixing unit 72 further backward from the above-described retracted position shown by dashed lines, and thereby the fixing unit 72 rotates further backward. By virtue of this structure, the user can easily replace the Bk cartridge and remove jammed paper without using extra strength, for example, without clicking sensation.

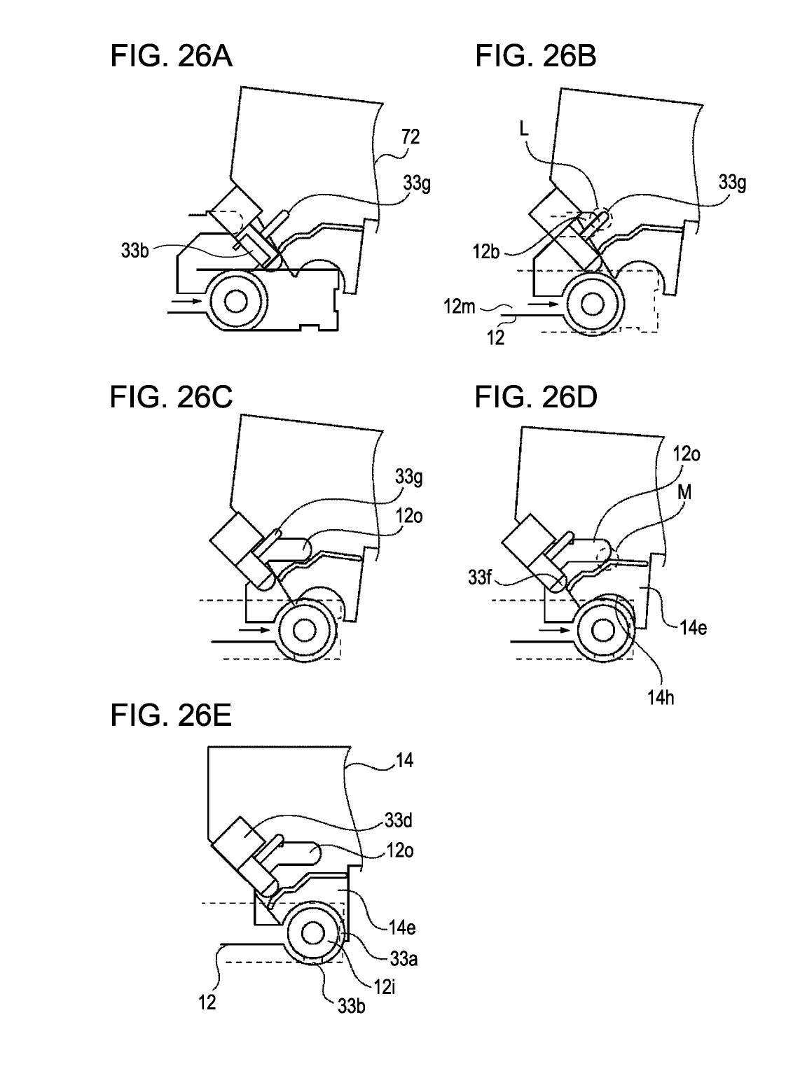

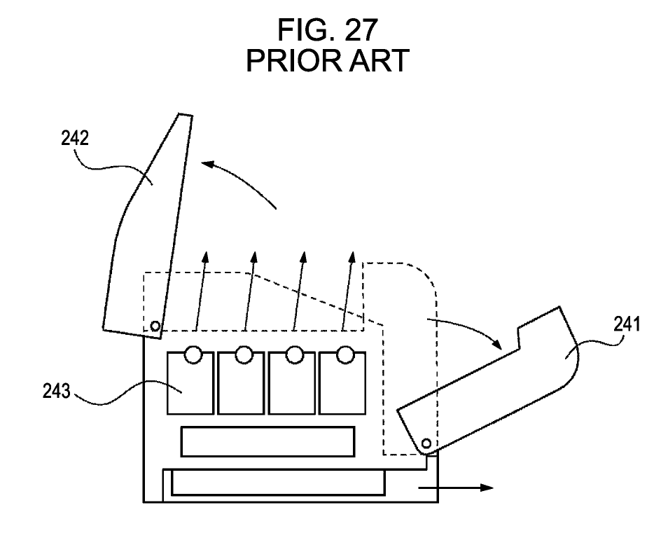

FIGS. 26A to 26E show in sequence how the mechanism operates when the belt unit 12 is slid and set in the main body.

When the user sets the fixing unit 72 at the retracted position, the fixing unit 72 stops at the position of FIG. 26A as described above.

As shown in FIG. 26B, when the belt unit 12 slides rightward, the boss 33g of the pressing member 33d is pushed up by the rib 12o of the casing 12m at the point L. As shown in FIG. 26C, the boss 33g passes over the rib 12o, thereby moving to the retracted position.

At the point M in FIG. 26D, the rib 12o pushes down the pressing block 14e, and thereby the bearing 12i is firmly fitted in the U-shaped portion 14h of the fixing unit 72.

As shown in FIG. 26E, pressed by the pressing member 33d, the belt unit 12 and the fixing unit 72 are firmly positioned in the main body.

In this embodiment, since the opening and closing unit slides horizontally to open and close relative to the main body of the apparatus, the user can open and close the opening and closing unit relative to the main body of the apparatus and remove and install the image forming units even when there is no large space above the apparatus.

Since this embodiment has the above-described structure and the fixing unit is rotatable backward so that the Bk cartridge can be replaced, the fixing unit can be disposed above the Bk cartridge and the depth of the main body of the apparatus can be reduced. Since the paper cassette is pulled out and the belt unit slides forward and the fixing unit rotates backward, the user can load paper, replace the cartridges, and remove jammed paper from the front of the main body. Since the fixing unit rotates in conjunction with the movement of the belt unit, the user can easily replace the cartridges and remove jammed paper.

Since the belt unit and the fixing unit are positioned in the main body by the same pressing members at the same positions, the belt unit and the fixing unit can be accurately and firmly positioned in the main body of the apparatus.

In this embodiment, the belt unit and the fixing unit perform fixing and releasing of the fixing unit to and from the main body of the apparatus in conjunction with each other. Alternatively, the fixing unit may be fixed to and released from the main body of the apparatus by operating, for example, a lever member after the belt unit is slid. The fixing unit may slide backward instead of rotating. By virtue of such structures, the user can easily replace the cartridges and remove jammed paper.

In this embodiment, the image forming units are substantially horizontally arranged, the belt unit thereabove is substantially horizontally moved, and the image forming units are removable from the main body of the apparatus in a space formed by the movement of the belt unit. By virtue of this, the height of the apparatus can be reduced.

Since the output tray above the belt unit is integrated with the belt unit and is movable together with the belt unit, the user can replace the image forming units with output sheets on the tray. Therefore, unlike in the case of the conventional clam shell structure, the user does not have to remove sheets on the tray.

Since the belt unit is retracted forward and in the same direction as the direction in which the paper cassette is pulled out, the user can load sheets of paper, replace the image forming units, and remove jammed paper from the front of the apparatus. The area that the apparatus occupies in use can be minimized even when the apparatus is installed on a desktop.

Since the belt unit is retracted in the same direction as the direction in which printouts are output from the apparatus, the user can easily access the output portion.

Since the belt unit has different retracted positions in accordance with the positions of the plurality of image forming units, the distance from the user to the image forming unit to be accessed is constant and the user can easily access even the backmost image forming unit.

When the user accesses the backmost image forming unit, the other image forming units are covered and protected by the opening and closing unit. This prevents the image bearing members and other components in the image forming units from being damaged, for example, by a falling object during operation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-341399 filed Dec. 19, 2006, which is hereby incorporated by reference herein in its entirety.

What is claimed is:

1. An image forming apparatus comprising:
an image forming unit configured to form an image;
a belt facilitating transferring an image formed by the image forming unit onto a recording material; and
an opening and closing unit having the belt and openable and closable relative to a main body of the apparatus,
wherein the belt is provided above the image forming unit, and the image forming unit is removable from the main body of the apparatus when the opening and closing unit is open, and
wherein the opening and closing unit slides substantially horizontally, thereby opening and closing relative to the main body of the apparatus.

2. The image forming apparatus according to claim 1, wherein the opening and closing unit has an output portion on which a recording material output from the main body of the apparatus is placed.

3. The image forming apparatus according to claim 1, wherein the image forming unit includes a plurality of image forming units, and the plurality of image forming units are arranged in the sliding direction of the opening and closing unit.

4. The image forming apparatus according to claim 1, further comprising a document reader unit configured to read a document, the document reader unit being disposed above the opening and closing unit.

5. The image forming apparatus according to claim 1, further comprising a fixing unit configured to fix an unfixed image on a recording material, the fixing unit being openable and closable relative to the main body of the apparatus.

6. The image forming apparatus according to claim 5, wherein the fixing unit overlaps at least part of the image forming unit as viewed in a vertical direction.

7. An image forming apparatus comprising:
a plurality of image forming units each configured to form an image;
a belt facilitating transferring images formed by the plurality of image forming units onto a recording material; and
an opening and closing unit having the belt and openable and closable relative to a main body of the apparatus,
wherein the belt is provided above the plurality of image forming units, and the plurality of image forming units are removable from the main body of the apparatus when the opening and closing unit is open, and
wherein the opening and closing unit slides substantially parallel to the arranging direction of the plurality of image forming units, thereby opening and closing relative to the main body of the apparatus.

8. The image forming apparatus according to claim 7, wherein the opening and closing unit has an output portion on which a recording material output from the main body of the apparatus is placed.

9. The image forming apparatus according to claim 7, further comprising a document reader unit configured to read a document, the document reader unit being disposed above the opening and closing unit.

10. The image forming apparatus according to claim 7, further comprising a fixing unit configured to fix an unfixed image on a recording material, the fixing unit being openable and closable relative to the main body of the apparatus.

11. The image forming apparatus according to claim 10, wherein the fixing unit overlaps at least part of one of the plurality of image forming units as viewed in a vertical direction.
